(19) United States
(12) Patent Application Publication
(10) Pub. No.: US 2017/0371356 A1
(43) Pub. Date: Dec. 28, 2017

(54) FLOW-RATE CONTROLLER UNIT

(71) Applicant: Neoperl GmbH, Mullheim (DE)

(72) Inventor: Simon Twitchett, Kidderminster (GB)

(73) Assignee: Neoperl GmbH, Mullheim (DE)

(21) Appl. No.: 15/541,644

(22) PCT Filed: Jan. 8, 2016
(86) PCT No.: PCT/EP2016/000027

§ 371 Date: Jul. 5, 2017

(30) Foreign Application Priority Data
Mar. 9, 2015 (DE) 202015001754.1

(51) Int. Cl. G05D 7/01; E03C 1/02; F16K 1/36

(52) U.S. Cl. CPC G05D 7/012; F16K 1/36; E03C 1/02; E03C 2001/026

(57) ABSTRACT

A flow-rate regulator unit (1) has an insert housing (2) which is insertable into a fluid line and in which a plurality of throughflow paths are provided, in at least one throughflow path of which in each case one flow-rate regulator (3, 4, 5) which regulates the amount of fluid flowing therethrough per time unit to a pressure-independent determined throughflow value is disposed, and in at least one further throughflow path of which in each case one closing valve (6) which under the pressure of the inflowing fluid is movable counter to a restoring force from an open position into a closing position is provided. The at least one flow-rate regulator (3, 4, 5) and the at least one closing valve (6) in each case have one annular throttle body or valve body (8, 9, 10; 7) of an elastic material, respectively, which under pressure of an impinging fluid is deformed in such a manner that the at least one flow-rate regulator (3, 4, 5) constricts a regulating gap and the at least one closing valve (6) closes at least one valve opening (11). The flow-rate regulator unit in the insert housing (2) has a first annular duct (12) which delimits a housing face of the insert housing (2), in which housing face at least two inboard annular ducts (13, 14, 15) are provided, the center of which in each case is disposed outside the housing face which is delimited by the other inboard annular ducts (13, 14, 15).

### BACKGROUND

The invention relates to a flow-rate regulator unit which has an insert housing which is insertable into a fluid line and in which a plurality of throughflow paths are provided, in at least one throughflow path of which in each case one flow-rate regulator which regulates the amount of fluid flowing therethrough per time unit to a pressure-independent determined throughflow value is disposed, and in at least one further throughflow path of which in each case one closing valve which under the pressure of the inflowing fluid is movable counter to a restoring force from an open position into a closing position is provided, wherein the at least one flow-rate regulator and the at least one closing valve in each case have one annular throttle body or valve body of an elastic material, respectively, which under the pressure of the inflowing fluid is deformed in such a manner that the at least one flow-rate regulator constricts a regulating gap and the at least one closing valve closes at least one valve opening.

A flow-rate regulator unit which has an insert housing which is insertable into a fluid line and in particular into a water supply line is already known from WO 202/156002. Two throughflow paths which are formed by annular ducts that are disposed so as to be mutually coaxial are provided in the insert housing of the previously known flow-rate regulator unit. While the annular throttle body, made from an elastic material, of a flow-rate regulator is placed into the one annular duct, a likewise annular valve body of a closing valve is provided in the other annular duct, said annular valve body being made from an elastically deformable material. The throttle body delimits a control gap between said throttle body and a duct wall that supports a control profile feature, the passage cross section of said control gap being modifiable by the throttle body which is deformed under the pressure differential that is formed during throughflow. By contrast, the valve body of the closing valve under the pressure of the medium flowing through moves counter to a restoring force from an open position into a closing position, the valve body in said closing position closing at least one valve opening. Since the annular ducts that are provided for the flow-rate regulator, on the one hand, and for the closing valve, on the other hand, are provided so as to be mutually coaxial in the insert housing, and since the housing cross section delimits the annular ducts, and the annular ducts also delimit one another, the variation potential is limited in the case of the previously known flow-rate regulator unit. While additional amounts of water can indeed be directed through the flow-rate regulator unit by way of the closing valve which at low pressures is initially still open, the regulating behavior of the previously known flow-rate regulator unit at high pressures depends on the regulating behavior of the flow-rate regulator used.

### SUMMARY

There is thus the objective of providing a flow-rate regulator unit of the type mentioned at the outset which operates and is capable of adjusting the required flow-rate in a very wide pressure range, specifically both at low pressures as well as at high pressures.

The solution according to the invention to this objective in the case of the flow-rate regulator unit of the type mentioned at the outset in particular lies in that, in the insert housing, a first outer annular duct which delimits a housing face of the insert housing is provided, in which housing face at least two inboard annular ducts are provided, the center of which in each case is disposed outside the housing face which is delimited by the other inboard annular ducts.

The flow-rate regulator unit according to the invention has an insert housing which is insertable into a fluid line. A plurality of throughflow paths are provided in the insert housing of this flow-rate regulator unit, in at least one throughflow path of which in each case one flow-rate regulator which is to regulate the amount of fluid flowing therethrough per time unit to the required throughflow value is disposed, and in at least one further throughflow path of which in each case one closing valve which under the pressure of the inflowing fluid is movable counter to a restoring force from an open position into a closing position is provided. In the case of low pressures at which the at least one closing valve remains in the open position thereof, an additional amount of fluid can flow through the flow-rate regulator unit according to the invention by way of the closing valve. As the pressure of the fluid rises in relation to said low pressures, the valve body of the closing valve moves into the closing position such that the flow-rate regulators can now adjust the throughflow of the flow-rate regulator unit according to the invention. The flow-rate regulators herein not only can be set to the same maximum value of throughflow, but also complement one another such that said flow-rate regulators adjust to dissimilar maximum values of throughflow. The at least one flow-rate regulator and the at least one closing valve herein in each case have one annular throttle body or valve body of an elastic material, respectively, which under the pressure of the inflowing fluid is deformed in such a manner that the at least one flow-rate regulator constricts a regulating gap and the at least one closing valve closes at least one valve opening. To this end, a first outer annular duct which can be assigned to either a closing valve or to one of the flow-rate regulators is provided in the insert housing of the flow-rate regulator unit according to the invention. This first outer annular duct delimits a housing face of the insert housing, in which housing face at least two inboard annular ducts are provided, the center of which in each case is disposed outside the housing face which is delimited by the other inboard annular ducts. By way of these annular ducts that in terms of their arrangement are largely independent, the flow-rate regulator unit according to the invention can be conceived in such a manner that said flow-rate regulator unit is capable of being advantageously employed in an operationally correct manner both at low pressures as well as at high pressures.

In order for the flow-rate regulator unit according to the invention to be able to be inserted in a simple manner into the usual line cross sections of a sanitary supply line, it is advantageous for the insert housing to be configured so as to be sleeve-shaped.

The annular ducts that are provided for the flow-rate regulators, on the one hand, and for the at least one closing valve, on the other hand, can be incorporated in a particularly simple manner into the insert housing of the flow-rate regulator unit according to the invention when, in the interior of the sleeve of the insert housing, a carrier plate which is oriented so as to be transverse to the throughflow direction is provided and which carrier plate has the annular ducts.

In order for the simple manufacturability of the flow-rate regulator unit according to the invention to be able to be additionally facilitated, and in order for said flow-rate regulator unit to be able to be assembled from as few components as possible, it is advantageous for the carrier plate to be integrally molded into the insert housing.

An embodiment of the invention in which the throttle bodies or valve bodies are inserted into the annular ducts located in the carrier plate from the inflow-side housing end face is preferred.

The manufacturability of the flow-rate regulator unit according to the invention from only a few components is yet additionally facilitated when the throttle bodies and valve bodies are secured in the annular ducts assigned thereto by means of a common securing element.

In order for the throttle bodies and valve bodies that are preferably inserted into the interior of the housing of the insert housing from the inflow-side housing end face to be able to be secured in the insert housing, it is advantageous for the common securing element to be held on the interior housing circumference of the housing part-region which is disposed on the inflow side in front of the carrier plate.

One preferred embodiment according to the invention herein provides that the common securing element by way of its outboard circumferential periphery is held in a retaining groove which is provided on the interior housing circumference of the housing part-region which is disposed in front of the carrier plate.

A particularly simple and readily manufacturable embodiment according to the invention provides that the securing element has a securing-element core from which preferably three securing arms radially protrude in an outward manner.

In order for the securing element not to excessively constrict the throughflow cross section toward the flow-rate regulator unit according to the invention and for the fluid thus to be able to readily flow past the securing element also in comparatively large quantities into the interior of the sleeve of the insert housing, it is advantageous for the securing element in its securing-element core to have a central throughflow opening.

One preferred refinement according to the invention provides that the centers of the inboard annular ducts are disposed in a triangle in relation to one another. The triangular arrangement of the inboard annular ducts facilitates the compact construction mode of the flow-rate regulator unit according to the invention, also in a comparatively small line cross section.

In order for the flow-rate regulator unit according to the invention to be able to be readily handled and to be able to be inserted in a sanitary supply line or else to be able to be retracted from an installation opening, for example, it is advantageous for the carrier plate on at least one end side, and preferably on the inflow-side end side thereof, to have a projecting handling pin. One preferred embodiment of the invention herein provides that this handling pin on the carrier plate projects in an approximately coaxial manner in relation to the housing longitudinal axis of the insert housing.

The first outer annular duct can be assigned to a flow-rate regulator that in the cross section is comparatively large, while by contrast at least two of the inboard annular ducts are used for flow-rate regulators that compared to the former are smaller, and the at least one remaining inboard annular duct is used for a closing valve. By contrast, a particularly advantageous embodiment provides that the outer first annular duct is assigned to the at least one closing valve, and that of the inboard annular ducts at least two are in each case assigned to one flow-rate regulator, while at least one further inboard annular duct serves the closing valve.

The compact construction mode of the flow-rate regulator unit according to the invention is yet facilitated when the regulator bodies of the flow-rate regulators between themselves and a control profile feature define the control gap, the average cross section of which is modifiable by the throttle body which is deformed by the pressure differential which is formed during throughflow.

The control profile feature herein can be provided on the inboard circumferential wall or duct wall of the assigned annular duct, and additionally or alternatively on the outboard circumferential wall or duct wall of the assigned annular duct.

In the case of one preferred embodiment of the flow-rate regulator unit according to the invention, it is provided that the annular duct of the at least one closing valve has the at least one valve opening in the region of the duct base of said annular duct.

The simple mode of operation and construction of the flow-rate regulator unit according to the invention herein is yet additionally facilitated when the valve body, counter to the restoring force of the inherent elasticity of the elastic material used for the valve body, moves from the open position into the closing position.

One preferred refinement of independent eligibility of protection provides that the annular duct of the at least one closing valve has a profile feature on an inboard and/or outboard duct wall. On account of this profile feature which here is provided on the outboard duct wall of the annular duct, better controllability of the closing valve during the closing procedure can be achieved, and disturbing noises and vibrations during the closing procedure can be avoided. The profile feature in the closing valve herein has the effect of no consistent velocity profile of the perfusing water across the circumference of the annular duct arising, but that instead the configuration of a uniform velocity profile or pressure profile, respectively, is compromised by the profile feature and by the spacings that are caused on account thereof, on account of which an undesirable resonance which is associated with disturbing noises and vibrations is avoided.

The profile features that are provided on the duct walls of the annular ducts that are specified for the flow-rate regulators and for the closing valve can be configured in an encircling manner on the duct wall.

One preferred embodiment of the invention herein provides that the profile feature(s) of the at least one flow-rate regulator and/or of the at least one closing valve are/is formed from alternating concave moldings and convex moldings which are oriented in the throughflow direction. Each convex molding herein can have a rounded and preferably a semicircular cross-sectional contour. By contrast, one preferred embodiment according to the invention provides that each concave molding is configured as that region that is disposed between two preferably directly mutually adjacent convex moldings.

### BRIEF DESCRIPTION OF THE DRAWINGS

Refinements of the invention are derived from the claims and from the drawing in conjunction with the description. The invention will be described in yet more detail hereunder by means of a preferred exemplary embodiment.

In the Figures:

FIG. 1 in a perspective illustration shows a flow-rate regulator unit which by way of the insert housing thereof is insertable into a fluid line, wherein the flow-rate regulator unit in the insert housing thereof has an outboard annular groove which defines a housing face in which presently three further inboard annular grooves are provided, the center of said inboard annular grooves in each case being disposed outside that housing face that is defined by the other inboard annular grooves;

FIG. 2 shows the flow-rate regulator unit of FIG. 1 in a plan view onto the inflow side of the former;

FIG. 3 shows the flow-rate regulator unit of FIGS. 1 and 2 in a longitudinal section through the section plane III-III of FIG. 2;

FIG. 4 shows the flow-rate regulator unit of FIGS. 1 to 3 in a view from below onto the outflow side of the former; and

FIG. 5 shows the flow-rate regulator unit of FIGS. 1 to 4 in an exploded perspective illustration of the individual component parts of the former.

### DETAILED DESCRIPTION OF THE PREFERRED EMBODIMENTS

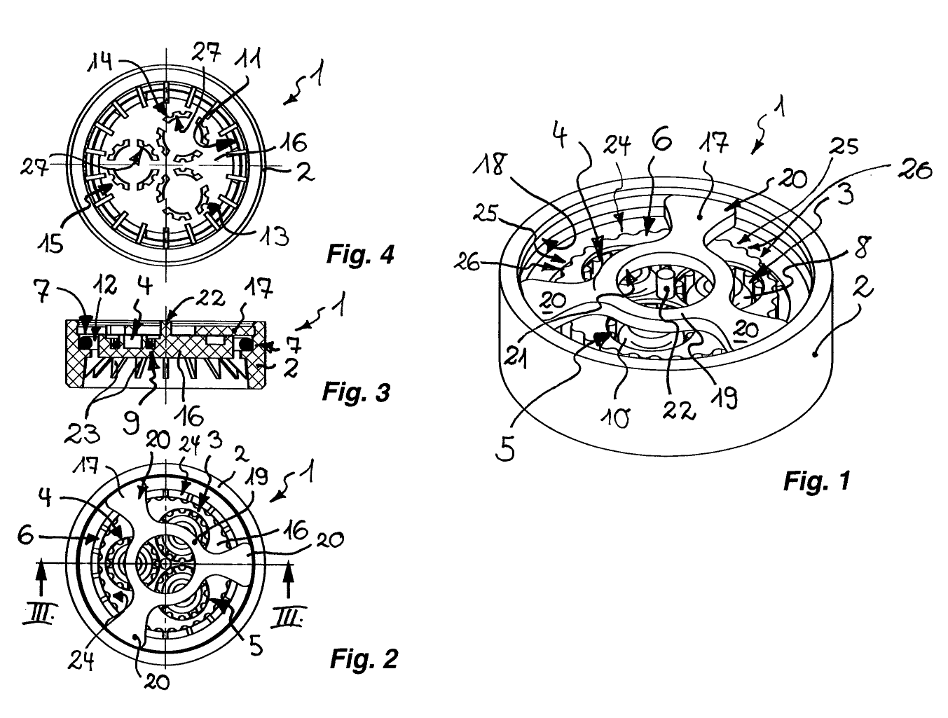

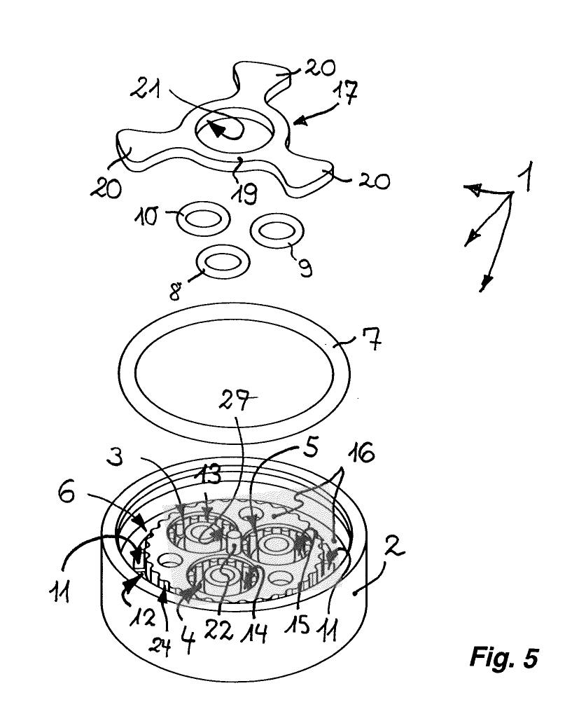

A flow-rate regulator unit 1 is illustrated in FIGS. 1 to 5. The flow-rate regulator unit 1 has an insert housing 2 which is insertable into a fluid line (not illustrated in more detail here). A plurality of throughflow paths are provided in the insert housing 2 of this flow-rate regulator unit 1, in at least one throughflow path of which in each case one flow-rate regulator 3, 4, 5 is disposed. The flow-rate regulators 3, 4, 5 of the flow-rate regulator unit 1 are intended to regulate the amount of fluid flowing therethrough per time unit in each case to a pressure-independent determined maximum value. In at least one further throughflow path in each case one closing valve 6 which under the pressure of the inflowing fluid is movable counter to a restoring force from an open position into a closing position is provided. In the case of low pressures at which the at least one closing valve 6 remains in the open position thereof, an additional amount of fluid can flow through the flow-rate regulator unit 1 by way of the closing valve 6. As the pressure of the fluid rises in relation to said low pressures, the valve body 7 of the closing valve 6 moves into the closing position such that the flow-rate regulators 3, 4, 5 can now adjust the throughflow of the flow-rate regulator unit 1. These flow-rate regulators 3, 4, 5 herein not only can be set to the same maximum value of throughflow, but also complement one another such that said flow-rate regulators 3, 4, 5 adjust to dissimilar maximum values of throughflow. To this end, the flow-rate regulators 3, 4, 5 can have control profile features and/or throttle bodies 8, 9, 10 of dissimilar design which differ in terms of the elasticity of the material used and/or correspondingly differ in terms of the elasticity of the cross-sectional shape. The flow-rate regulators 3, 4, 5 and the at least one closing valve 6 herein in each case have one annular throttle body or valve body 8, 9, 10; 7 of an elastic material, respectively, which under the pressure of the inflowing fluid is deformed in such a manner that the flow-rate regulators 3, 4, 5 constrict in each case one regulating gap and the at least one closing valve 6 closes at least one valve opening 11.

A first outboard annular duct 12 which can be assigned to either one of the flow-rate regulator or as in the present case to the closing valve 6 is provided in the insert housing 2 of the flow-rate regulator unit 1. This outboard annular duct 12 defines a housing face of the insert housing 2, in which housing face at least two and in the present case three inboard annular ducts 13, 14, 15 are provided, the center of which in each case is disposed outside of the housing face which is defined by the other inboard annular ducts 13, 14, or 15, respectively. The inboard annular ducts 13, 14, 15 and in the present case also additionally the outer first annular duct 12 are thus disposed so as not to be mutually concentric.

By way of these annular ducts 12, 13, 14, 15 that in terms of their arrangement are largely independent, the flow-rate regulator unit 1 can be conceived in such a manner that said flow-rate regulator unit 1 is capable of being advantageously employed in an operationally correct manner both at very low pressures as well as at high pressures. As is highlighted by FIGS. 1, 2, and 5, the insert housing 2 of the flow-rate regulator unit 1 is configured so as to be sleeve-shaped. In the interior of the sleeve of the insert housing 2 a carrier plate 16 which is oriented so as to be transverse to the throughflow direction is provided and which has the annular ducts 12, 13, 14, 15. The carrier plate 16 can be placed into the insert housing 2. In the exemplary embodiment shown here, the carrier plate 16 is integrally molded into the insert housing 2 and on the outflow side thereof is carried by retaining ribs 23 which engage on the carrier plate 16, on the one hand, and on the housing circumferential wall, on the other hand.

The valve bodies or throttle bodies 7; 8, 9, 10 are inserted into the annular ducts 12; 13, 14, 15 from the inflow-side housing end face. The valve bodies and throttle bodies 7; 8, 9, 10 herein are secured in the annular ducts 12, 13, 14, 15 assigned thereto by means of a common securing element 17. The securing element 17 that can be particularly readily seen in FIGS. 1, 2, and 5 is held on the interior housing circumference of the housing part-region which is disposed on the inflow side in front of the carrier plate 16. The common securing element 17 has a securing-element core 19 from which in the present case three securing arms 20 protrude in an outward manner. The free arm ends of the securing arms 20 that form the outboard circumferential periphery of the securing element 17 engage in a retaining groove 18 which is disposed on the internal circumference on the housing part-region that is disposed in front of the carrier plate 16.

In order for the securing element 17 that is disposed on the inflow side of the flow-rate regulator unit 1 not to compromise and disturb the throughflow of the fluid through the flow-rate regulator unit 1, the securing element 17 on the securing-element core 19 thereof has a central throughflow opening 21. It can be seen in FIGS. 2, 4, and 5 that the centers of the inboard annular ducts 13, 14, 15 are disposed in a triangle in relation to one another. The securing element 17 covers the annular ducts 12; 13, 14, 15 of the flow-rate regulators 3, 4, 5, on the one hand, and of the closing valve 6, on the other hand, such that the valve bodies and throttle bodies 7; 8, 9, 10 that are located in the annular ducts 12; 13, 14, 15 are secured therein.

In order for the flow-rate regulator unit 1 to be able to be readily handled and to be inserted in the insert opening that is located in a fluid line, for example, the carrier plate 16 on at least one end side and preferably, as in the present case, on the inflow-side end side thereof has a projecting handling pin 22. This handling pin 22 in an approximately coaxial manner in relation to the housing longitudinal axis of the insert housing 2, and counter to the throughflow direction, on the carrier plate 16 projects through the central throughflow opening 21 of the securing element 17.

The regulator bodies or throttle bodies 8, 9, 10 of the flow-rate regulators 3, 4, 5 between themselves and a control profile feature 27 delimit a control gap, the passage cross section of which is modifiable by the throttle body 8, 9, 10 which is deformed by the pressure differential which is formed during throughflow. The control profile feature 27 herein is provided on an inboard and additionally or alternatively, as is the case here, on an outboard duct wall or circumferential wall of the assigned annular duct 13, 14, 15.

The outer first annular duct 12 of the at least one closing valve 6 in the region of the groove base thereof has the at least one valve opening 11. The valve body 7 of the closing valve 6 that is provided in this annular duct 12 and is likewise made from an elastic material, counter to the restoring force of the inherent elasticity of the elastic material used for the valve body 7, moves from the open position into the closing position as soon as the fluid pressure of the inflowing fluid exceeds a limit value. The annular duct 12 of the at least one closing valve, on an inboard and/or outboard duct wall, has a profile feature 24. By way of this profile feature 24 of the closing valve 6, improved controllability of the closing valve 6 during the closing procedure can be achieved, and disturbing noises and vibrations can also be prevented. The profile feature 24 in the closing valve 6 herein has the effect of a consistent velocity profile of the perfusing water across the circumference being effectively prevented, because the configuration of a uniform velocity profile or pressure profile, respectively, of the perfusing water is disturbed by the spacings that are caused as a consequence of the profile feature 24.

It is particularly advantageous that the annular duct 12 of the at least one closing valve 6 has the profile feature 24 on an inboard and/or outboard duct wall. By way of this profile feature 24 which here is provided on the inboard duct wall of the annular duct 12, better controllability of the closing valve 6 during the closing procedure can be achieved, and disturbing noises and vibrations during the closing procedure can be avoided. The profile feature 24 in the closing valve 6 herein has the effect of no consistent velocity profile of the perfusing water across the circumference of the annular duct 12 arising, but that instead the configuration of a uniform velocity profile or pressure profile, respectively, is compromised by the profile feature 24 and by the spacings that are caused on account thereof, on account of which an undesirable resonance which is associated with disturbing noises and vibrations is avoided.

The profile features that are provided on the duct walls of the annular ducts 12, 13, 14, 15 that are specified for the flow-rate regulators 3, 4, 5 and for the closing valve 6 can be designed so as to be encircling on the duct wall.

One preferred embodiment according to the invention herein provides that the control profile feature(s) 27 of the at least one flow-rate regulator 3, 4, 5 and the profile feature 24 of the at least one closing valve 6 are formed from alternating concave moldings 25 and convex moldings 26 which are oriented in the throughflow direction. The concave moldings 25 and convex moldings 26 herein can have a rounded and preferably a semicircular cross-sectional contour. By contrast, one further embodiment of the invention (not shown here) provides that each concave molding 25 is configured as that region that is disposed between two preferably directly mutually adjacent convex moldings 26.

A particular advantage of the flow-rate regulator unit 1 that is illustrated here and is insertable into a sanitary water supply line, for example, is that said flow-rate regulator unit 1 is advantageously employable both at very low pressures as well as at very high pressures, for example in a range between 0.5 and approximately 12 bar.

### LIST OF REFERENCE SIGNS

1 Flow-rate regulator unit
2 Insert housing
3 Flow-rate regulator
4 Flow-rate regulator
5 Flow-rate regulator
6 Closing valve
7 Valve body
8 Throttle body
9 Throttle body
10 Throttle body
11 Valve opening
12 First annular duct
13 Inboard annular duct
14 Inboard annular duct
15 Inboard annular duct
16 Carrier plate
17 Securing element
18 Retaining groove
19 Securing-element core
20 Securing arms
21 Central throughflow opening
22 Handling pin
23 Retaining ribs
24 Profile feature (in the closing valve 6)
25 Concave molding
26 Convex molding
27 Profile feature in the flow-rate regulators 3, 4, 5

1. A flow-rate regulator unit (1) comprising an insert housing (2) which is insertable into a fluid line and in which a plurality of throughflow paths are provided, a flow-rate regulator (3, 4, 5) located in at least one of the throughflow paths, the flow-rate regulator regulates an amount of fluid flowing therethrough per time unit to a pressure-independent determined throughflow value, at least one further throughflow path, a closing valve (6) located in the at least one further throughflow path, the closing valve under the pressure of an inflowing fluid is movable counter to a restoring force from an open position into a closing position, flow-rate regulator (3, 4, 5) and the closing valve (6) in each case have an annular throttle body or valve body (8, 9, 10; 7) of an elastic material, respectively, which under pressure of an impinging fluid is deformed in such a manner that the flow-rate regulator (3, 4, 5) constricts a regulating gap and the one closing valve (6) closes at least one valve opening (11), a first annular duct (12) which delimits a housing face of the insert housing (2) is provided in the insert housing (2), in which housing face at least two inboard annular ducts (13, 14, 15) are provided, a center of which in each case is disposed outside the housing face which is delimited by the other inboard annular ducts (13, 14, 15).

2. The flow-rate regulator unit (1) as claimed in claim 1, wherein the insert housing (2) is configured so as to be sleeve-shaped.

3. The flow-rate regulator unit as claimed in claim 2, further comprising a carrier plate (16) in an interior of the sleeve of the insert housing (2), the carrier plate (16) is oriented so as to be transverse to the throughflow direction and has the annular ducts (12, 13, 14, 15).

4. The flow-rate regulator unit as claimed in claim 3, wherein the carrier plate (16) is integrally molded into the insert housing (2).

5. The flow-rate regulator unit as claimed in claim 1, wherein the throttle bodies or valve bodies (8, 9, 10; 7) are inserted into the annular ducts (13, 14, 15; 12) from an inflow-side housing end face.

6. The flow-rate regulator unit as claimed in claim 1, wherein the throttle bodies and valve bodies (8, 9, 10; 7) are secured in the annular ducts (13, 14, 15; 12) assigned thereto by a common securing element (17).

7. The flow-rate regulator unit as claimed in claim 3, wherein the common securing element (17) is held on an interior housing circumference on a housing part-region which is disposed on an inflow side in front of the carrier plate (16).

8. The flow-rate regulator unit as claimed in claim 7, wherein the common securing element (17) by way of an outboard circumferential periphery thereof is held in a retaining groove (18) which is provided on a interior housing circumference of the housing part-region which is disposed in front of the carrier plate (16).

9. The flow-rate regulator unit as claimed in claim 8, wherein the securing element (17) has a securing-element core (19) from which securing arms (20) radially protrude in an outward manner.

10. The flow-rate regulator unit as claimed in claim 9, wherein the securing element (17) has a central throughflow opening (21) in the securing element core.

11. The flow-rate regulator unit as claimed in claim 1, wherein centers of the inboard annular ducts (13, 14, 15) are disposed in a triangle in relation to one another.

12. The flow-rate regulator unit as claimed in claim 3, wherein the carrier plate (16) on at least one end side has a projecting handling pin (22).

13. The flow-rate regulator unit as claimed in claim 12, wherein the handling pin (22) on the carrier plate (16) projects in an approximately coaxial manner in relation to a housing longitudinal axis of the insert housing (2).

14. The flow-rate regulator unit as claimed in claim 1, wherein the first annular duct (12) is assigned to the at least one closing valve (6), and of the inboard annular ducts (13, 14, 15) which lie opposite thereto at least two are in each case assigned to one of the flow-rate regulators (3, 4, 5).

15. The flow-rate regulator unit as claimed in claim 1, wherein the throttle bodies (8, 9, 10) of the flow-rate regulators (3, 4, 5) between themselves and a control profile feature in each case define a control gap, a passage cross section of which is modifiable by the throttle body (8, 9, 10) which is deformed by a pressure differential which is formed during throughflow.

16. The flow-rate regulator unit as claimed in claim 1, wherein control profile features are provided on at least one of inboard or outboard duct walls of the assigned annular duct (13, 14, 15).

17. The flow-rate regulator unit as claimed in claim 1, wherein the annular duct (12) of the closing valve (6) has the at least one valve opening (11) in a region of a duct base of said annular duct (12).

18. The flow-rate regulator unit as claimed in claim 1, wherein the valve body (7), counter to a restoring force of the inherent elasticity of the elastic material used for the valve body (7), moves from an open position into a closing position.

19. The flow-rate regulator unit as claimed in claim 1, wherein the annular duct (12) of the closing valve (6) has a profile feature (24) on at least one of an inboard or outboard duct wall.

20. The flow-rate regulator unit as claimed in claim 1, wherein a profile feature of the flow-rate regulator (3, 4, 5) or of the closing valve (6) is configured in an encircling manner on an duct wall of the assigned annular duct (12, 13, 14, 15).

21. The flow-rate regulator unit as claimed in claim 1, wherein a control profile feature (27) of the flow-rate regulator (3, 4, 5) or the profile feature (24) of the closing valve (6), or both, are formed from alternating concave moldings (25) and convex moldings (26) which are oriented in the throughflow direction.

22. The flow-rate regulator unit as claimed in claim 21, wherein at least one of the concave moldings (25) or the convex moldings (26) have a polygonal or a rounded cross-sectional contour.
